(19) United States
(12) Patent Application Publication
(10) Pub. No.: US 2026/0365926 A1
(43) Pub. Date: Nov. 19, 2026

(54) CRACKING METHOD

(71) Applicant: INEOS EUROPE AG, Vaud (CH)

(72) Inventors: Bernard DESCALES, Marseille (FR); Philippe Charles Yves LALANNE MAGNE, Saint Mitre Les Remparts (FR)

(21) Appl. No.: 19/139,431

(22) PCT Filed: Nov. 30, 2023
(86) PCT No.: PCT/EP2023/083763

§ 371 Date: Jun. 16, 2025

(30) Foreign Application Priority Data
Dec. 15, 2022 (EP) 22213922.2

(51) Int. Cl. C10G 9/24

(52) U.S. Cl. CPC C10G 9/24; C10G 2300/4031

(57) ABSTRACT

A method for transitioning from cracking a first hydrocarbon feed to cracking a second hydrocarbon feed. The first process includes passing the first hydrocarbon feed to a reactant tube having first and second zones each having one or more electrically heated sections, heating/vaporizing the first hydrocarbon feed in a first zone, and heating/cracking the vaporised first hydrocarbon feed in a second zone. Transitioning includes stopping the feeding of the first hydrocarbon feed and starting the feeding of the second hydrocarbon feed. The second process includes passing the second hydrocarbon feed to the same reactant tube, heating/vaporizing the second hydrocarbon feed in the first zone, and heating/cracking the vaporised second hydrocarbon feed in the second zone. The number of heated sections in the first and second zones in the first hydrocarbon feed is different from the number of heated sections in the first and second zones in the second hydrocarbon feed.

### FIELD AND BACKGROUND OF THE INVENTION

The present invention relates to methods of cracking hydrocarbon feeds, and in particular in electrically heated furnaces.

Cracking of hydrocarbons generally takes place in a furnace. In steam cracking, for example, the hydrocarbon feed to be cracked, with steam, is typically passed through a reactant tube in the furnace, which tube is heated. In conventional furnaces the heat is provided by burners located on the insides of the furnace, which generate the heat for cracking by combustion of a fuel.

The commercial cracking of hydrocarbons generally takes place at a temperature above 750 °C. Prior to cracking at such temperatures the hydrocarbons to be cracked are vaporised, and for this reason the hydrocarbons are usually heated and vaporised in a convection section of a furnace before being passed to a burner section where the cracking occurs.

In many conventional designs heating and vaporisation is done in what is known as the “convection section” of the furnace, which is a section located above the section where cracking occurs. (This latter is generally referred to as the “radiation section”.) The hydrocarbon to be cracked is fed through tubes located in the convection section, and combustion gases from the burners in the radiation section, which are still hot after leaving the section, are used to heat and vaporise the hydrocarbon to be cracked.

Steam cracking can be performed on different hydrocarbon feeds. These include “light” hydrocarbon feeds, such as ethane, “medium” feeds, such as naphtha, and “heavy” feeds, such as pyrolysis oils.

Generally, the cracking of different feeds takes place at similar temperatures, typically above 750 °C as already noted, although the optimum temperature tends to be slightly higher for lighter feeds than heavier ones, and the optimum residence time also tends to be longer for lighter feeds. In contrast, it takes more energy to heat and vaporise medium and heavy feeds than it does light ones.

For these reasons, a “conventional” furnace designed to vaporise and crack a naphtha feed is generally not optimally designed for vaporising and cracking an ethane containing feed. For example, the number of tubes in the convection section required to fully vaporise naphtha tends to be more than are required to full vaporise ethane, but not sufficient to fully vaporise heavier feeds.

Steam cracking furnaces based on electrical heating rather than burners have been proposed. In such designs both the vaporisation and cracking steps can use electrical heating.

A particular advantage of electrical heating is that it can provide more control of the temperature of individual sections of the furnace/reactant tube.

U.S. Pat. No. 7,288,690 describes a method and apparatus for steam cracking hydrocarbons in which cogeneration using combustion of a fuel is used to produce simultaneously both heat energy and mechanical work which is transformed into electricity, and wherein the mixture is initially subjected to heating using the heat energy supplied by the cogeneration and is subsequently heated to the desired cracking temperature by means of electrical heating using the electricity supplied by the cogeneration.

WO 2022/094455 discloses an electrically heated cracking furnace. According to this document different reactant coils may be fed with different hydrocarbons or a mix of hydrocarbon feeds and the heating can be varied depending on the feed to be cracked. This document also discloses that preheating can be provided outside of the main reactor to provide preheating to each feed.

### SUMMARY OF THE INVENTION

We have now found a method which enables the cracking of different hydrocarbon feeds to be optimally cracked in the same furnace.

Thus, in a first aspect there is provided a method for transitioning from a first process cracking a first hydrocarbon feed to a second process cracking a second hydrocarbon feed, wherein:

a) The first process comprises
a. passing the first hydrocarbon feed to a reactant tube which reactant tube comprises a first zone and a second zone, downstream of the first zone, each zone comprising one or more electrically heated sections,
b. heating the first hydrocarbon feed in the first zone in the one or more electrically heated sections to vaporise the first hydrocarbon feed, and
c. heating the vaporised first hydrocarbon feed in the second zone in the one or more electrically heated sections to crack the first hydrocarbon feed,
wherein the number of heated sections in the first zone is n1, the number of heated sections in the second zone is n2, and n1+n2 is equal to n, where n it the total number of heated sections,

b) The transition comprises stopping the feeding of the first hydrocarbon feed to the reactant tube and starting the feeding of the second hydrocarbon feed to the same reactant tube, and

c) The second process comprises
a. passing the second hydrocarbon feed to the reactant tube which reactant tube comprises a first zone and a second zone, downstream of the first zone, each zone comprising one or more electrically heated sections,
b. heating the second hydrocarbon feed in the first zone in the one or more electrically heated sections to vaporise the second hydrocarbon feed, and
c. heating the vaporised second hydrocarbon feed in the second zone in the one or more electrically heated sections to crack the second hydrocarbon feed,
wherein the number of heated sections in the first zone is m1, the number of heated sections in the second zone is m2, and m1+m2 is equal to n,
and wherein the second hydrocarbon feed is different to the first hydrocarbon feed, m1 n1 and m2 n2.

The first aspect of the present invention provides a method of transitioning. By the method being a “transition” is generally meant that the second hydrocarbon feed has a significantly different composition and/or boiling point range to the first hydrocarbon feed. (And because of this a change in the heat required to vaporise the feed is required.) Preferably the final boiling point of the boiling point range of the second hydrocarbon feed is at least 20 °C different (higher or lower) than the final boiling point of the boiling point range of the first hydrocarbon feed. The second hydrocarbon feed may be of a different type to that of the first hydrocarbon feed. For example, cracking feeds may be generally characterised as either “ethane based”, “propane based”, ‘butane based”, “naphtha based” or “pyrolysis based” such as pyrolysis oil obtained from plastic recycling, and hence a change from one to another of these would be a transition.

The first process comprises passing the first hydrocarbon feed to a reactant tube. The reactant tube has a total of n electrically heated sections. These heated sections are set up to provide a first zone having n1 heated sections in which the first hydrocarbon feed is heated to vaporise the first hydrocarbon feed and a second zone having n2 heated sections in which the vaporised first hydrocarbon feed is further heated to crack the first hydrocarbon feed.

n1 and n2 may each be one or more, and n1+n2 is equal to the total number of heated sections, n.

In general, the term “electrically heated section” generally means a section of the reactant tube which is heated directly or indirectly by electrical energy. “Direct” heating may comprise, for example, applying electrical energy directly to the reactant tube. “Indirect” heating may comprise, for example, using one or more heating elements which heat the reactant tube through one or more of radiation and convection and induction.

Typically, the heating applied to and hence the temperature of each electrically heated section is individually controllable. Generally, each electrically heated section will have one or more electric heaters associated with that section.

It should be apparent that there must be at least 3 heated sections (n must be at least 3) in order for the number of heated sections in the first and second zones to be changed whilst retaining at least one heated section in each zone before and after the transition. There is no particular limit on the maximum number of heated sections in the reactant tube, or how the reactant tube is separated into the different heated sections. Conveniently, each heater on the reactant tube may define a single heated section. In this case there is one heater per heated section. For example, if the reactant tube has 20 heaters distributed along its length then this may be considered as 20 heated sections. However, a heated section may be heated by more than one electric heater. For example, a heated section may be heated by two or more heaters located on different sides of the same section. However the heated sections are set, the present invention simply requires that the number of said heated sections in the first zone and in the second zone is changed during the transition. Typically there are 4 to 30 heated sections in total (n is 4 to 30).

Typically there will be more than one reactant tube, these being provided in parallel so that vaporisation and cracking can take place in each tube.

In the first zone the hydrocarbon feed is heated in one or more electrically heated sections to vaporise the hydrocarbon feed. Typically the hydrocarbon feed is heated to a temperature which is sufficient to vaporise the feed but insufficient to cause cracking, or at least not significant levels of cracking. The most preferred temperature will be different depending on the hydrocarbon feed, but the temperature at the exit of the first zone is typically less than 600 °C. (This being applicable to the first and second hydrocarbon feeds.)

In the second zone the vaporised hydrocarbon feed is further heated to crack the hydrocarbon feed. The most preferred temperature for the cracking will be different depending on the hydrocarbon feed, but the temperature at the exit of the second zone is generally at least 700 °C, and more usually (and preferably), at least 750 °C. (These temperatures being applicable to the first and second hydrocarbon feeds.)

(For avoidance of doubt, in the present invention reference to the temperature of a feed or reactant stream refers to the temperature of the stream. Thus the temperature refers to the temperature of the vaporised hydrocarbon at the end of the first zone or the cracked gas at the end of the second zone.)

The heating applied in each zone, and in particular to each heated section, may be controlled by control of the electrical energy. This may be adjusted using a suitable process control system and based on the feed to be cracked.

In the first aspect of the present invention a transition is performed from the first process cracking the first hydrocarbon feed to a second process cracking a second hydrocarbon feed. In particular, the transition comprises stopping the feeding of the first hydrocarbon feed to the reactant tube and starting the feeding of the second hydrocarbon feed to the same reactant tube. (And in the situation where multiple reactant tubes are present, this step is usually performed for all reactant tubes.)

Since it is the same reactant tube the reactant tube still has the same total (n) of electrically heated sections. For the second process, however, these heated sections are set up to provide a first zone having m1 heated sections in which the first hydrocarbon feed is heated to vaporise the second hydrocarbon feed and a second zone having m2 heated sections in which the vaporised second hydrocarbon feed is further heated to crack the second hydrocarbon feed, where m1 #n1 and m2 #n2.

Thus, in the second process a different number of heated sections form the first zone than in the first process, and also for the second zone.

Typically, if the final boiling point of the boiling point range of the second hydrocarbon feed is higher than the final boiling point of the boiling point range of the first hydrocarbon feed, then more energy is required to vaporise the feed. Thus, the number of heated sections in the first zone is increased during the transition (m1>n1). Correspondingly, the number of heated sections in the second zone is reduced (m2<n2).

If the opposite is the case, and the final boiling point of the boiling point range of the second hydrocarbon feed is lower than the final boiling point of the boiling point range of the first hydrocarbon feed, then less energy is required to vaporise the feed. Thus, the number of heated sections in the first zone can be decreased during the transition (m1<n1) and the number of heated sections in the second zone can be increased (m2>n2).

The specific “change” of a heating section so that is becomes part of the first zone rather than the second zone or vice versa may be achieved by adjusting the temperature in heating sections as required. For example, if during a transition, it is desired to increase the number of heating sections in the first zone, the electrical energy input can be adjusted so that the temperature in what was previous the first heating section of the second zone is reduced from a temperature sufficient for cracking to one that is sufficient only to vaporise the feed. This heating section then becomes part of the first zone.

(It will be apparent that process parameters other than the number of heating sections in each zone can also be adjusted. For example, hydrocarbon feed rate, and hence residence times in the first and second zones, can also be adjusted depending on the hydrocarbon feed, as can the amount of heat energy applied to different heating sections.)

The number of heated sections in the first zone during the first process, n1, one or two sections more or less than m1, or may be three or more sections more or less than the number of heated sections in the first zone during the second process, m1.

The present invention takes advantage of the superior controllability of furnaces based on electrical heating compared to fired (burner based) furnaces. In particular, the amount of heating from an individual electrical heater can be finely controlled between zero and the maximum rating of the heater, and thus the individual heated sections can be adapted easily to be used for either vaporisation or cracking. As already noted, each heated section in a zone may be heated by a single electric heater or by several electric heaters. Either way, “fine” adjustments can be made to the heat supplied to each zone and the cracking can therefore be optimised when the feed composition changes.

For avoidance of doubt, when referring in the present invention to a heating section having one or more electric heaters, this means that each heating section has its own electric heater or heaters, and the electric heater(s) on a particular section are different and distinct to electric heater(s) on a different section.

The first aspect arises from the ability to control the electric heating of the different sections and zones, and in particular to adjust the number of heating sections in each zone. This can also provide advantages in start-up and also in long term operation i.e. not just during a transition.

Thus, in a second aspect there is provided a method for starting a process for cracking a hydrocarbon feed, wherein the process at steady state comprises
a) passing the hydrocarbon feed to a reactant tube which reactant tube comprises a first zone and a second zone, downstream of the first zone, the first zone comprising one or more electrically heated sections and the second zone comprising two or more electrically heated sections,
b) heating the hydrocarbon feed in the first zone in the one or more electrically heated sections to vaporise the hydrocarbon feed, and
c) heating the vaporised hydrocarbon feed in the second zone in the two or more electrically heated sections to crack the hydrocarbon feed,
   wherein the number of heated sections in the first zone is n1, the number of heated sections in the second zone is n2, and n1+n2 is equal to n, where n it the total number of heated sections,
wherein the start-up of the process comprises
   a. starting the feeding of the hydrocarbon feed to the reactant tube,
   b. heating the hydrocarbon feed in a first zone comprising two or more electrically heated sections to vaporise the hydrocarbon feed, and
   c. heating the vaporised hydrocarbon feed in a second zone comprising one or more electrically heated sections to crack the hydrocarbon feed,
   wherein the number of heated sections in the first zone at start-up is s1, the number of heated sections in the second zone at start-up is s2, and s1+s2 is equal to n, and wherein s1>n1 and s2<n2.

In this aspect the number of heated sections used to provide each of the first and second zones is different at start-up than during steady state operation. In particular, additional heating sections (s1>n1) are provided for vaporising the feed during start-up than at steady state.

Typically, at steady state, the product stream comprises hot cracked product from which heat can be recovered. Advantageously, and commonly, this heat/energy is used to provide pre-heating of incoming fresh hydrocarbon feed, which reduces the amount of heating required to vaporise the feed in the first zone.

At start-up the hydrocarbon stream exiting the reactor will generally be at lower temperatures than when at steady state, so can provide less energy for pre-heating the fresh feed. In the present invention, additional heating sections are therefore provided to enable increased heating of the fresh feed in the first zone.

As the temperature of the product stream (exiting the second zone) increases and can be used to provide pre-heating then the number of sections in the first zone is reduced to n1 required for steady state operation. (And correspondingly the number in the second zone is then increased, which enables higher cracking yield to be obtained.)

Other parameters may also be varied during start-up. For example, lower feed rates may be used initially than those at steady state, to increase the residence time of the hydrocarbon feed in the reactant tube, and in particular in the second zone, which has less heating sections than at steady state.

The number of heated sections in the first zone at start-up, s1, may be one more than the number of heated sections in the first zone at steady state, n1, or may be two or more (than n1).

Where s1 is two or more greater than n1 at the start of the start-up then it will be apparent that there may be intermediate stages between the initial start-up and the steady state operation where the first zone has a number of heating sections between s1 and n1, and similarly for the second zone.

### BRIEF DESCRIPTION OF THE FIGURES

FIG. 1 is a schematic diagram of one embodiment of a reactant tube for use in the method of the present invention.

FIG. 2 is a schematic diagram of another embodiment of a reactant tube for use in the method of the present invention.

### DETAILED DESCRIPTION OF THE INVENTION

In a preferred embodiment, applicable to either of the first and second aspects, the cracking process comprises a quench section provided downstream of the heated sections of the reactant tube in which the cracked products (of first and second hydrocarbon feeds respectively) are cooled. In one embodiment the cooling may be by indirect heat exchange, for example with water to generate steam.

In a preferred embodiment the cracked product stream is cooled by indirect heat exchange with incoming (fresh) hydrocarbon feed. This provides preliminary pre-heating of the hydrocarbon feed which is then passed to the reactant tube and reduces the amount of energy for vaporisation in the upstream heated sections.

In embodiments, the first and/or second hydrocarbon feed may be analysed prior to entry to the first zone and/or between the first zone and the second zone. The electrical energy provided to the one or more electrically heated sections in the first zone and/or in the second zone may then be controlled based on the results of the analysis.

In one embodiment, an analyser is located upstream of the first zone and operated to provide analysis on the hydrocarbon feed, and which can then be used to control the electrically heated sections in the first and second zones. Suitable analysis methods include GC, Near-IR analysis and density measurements. The analysis in this embodiment preferably provides information on the boiling point range of the hydrocarbon feed. This may be an actual boiling point range, or other information indicative thereof, such as a density measurement.

An alternative embodiment involves analysis to measure the presence of a liquid phase, for example with an ultrasound sensor, on the hydrocarbon feed between the first zone and the second zone. The heating in the first zone may then be adapted accordingly, for example to increase the heating if liquid is observed. The heating in the second zone, for example in earlier sections of the second zone could also be adjusted based on such a measurement.

The control of the electrical energy to control the electrically heated sections in the first and/or second zones will be adjusted using a suitable process control system i.e. the result of the analyses are passed to process control system for the cracking reaction, and this will adjust the energy inputs accordingly.

More generally, the methods of the present invention may be applied for cracking on any hydrocarbon feed which can be cracked in similar processes and methods. These include those discussed, for example, in U.S. Pat. No. 7,288,690 and WO 2022/094455 already noted. The present invention may be used to crack halogenated hydrocarbons, including cracking of dichloroethane. Preferred cracking processes to which the present invention can be applied are processes for cracking of hydrocarbons to produce olefins. Suitable hydrocarbon feeds for cracking, and in particular to produce olefins, include ethane, propane, butane, naphtha, gasoil, gas condensate, pyrolysis oils, and mixtures thereof.

A particularly preferred cracking process to which the present invention can be applied is the steam cracking of hydrocarbons, and in particular of the hydrocarbon feeds noted above.

Other than the requirements defined in the present invention, the general process conditions, such as the feed flow rates, ratios of reactants, such as steam, residence times and cracking temperatures and the like are largely as for conventional processes. Similarly the feeding systems and downstream systems, such as quench systems and/or heat exchange of reactant and feed streams may all be present and applied as for conventional cracking processes.

As already noted, the “electrically heated section” can be heated directly or indirectly by electrical energy. Typically, the reactant tube/heated sections thereof are provided inside a furnace or heating chamber. A gas, preferably an inert gas, may be provided inside the chamber. Example of suitable electrically heated furnaces can be found in WO 2022/094455 already noted, or WO 2020/002326.

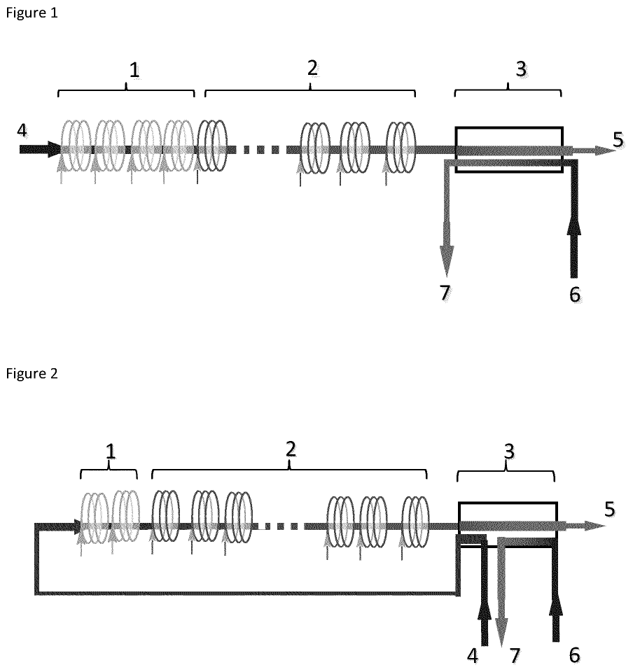

Some embodiments of the present invention are illustrated in FIGS. 1 and 2 and the following Examples.

FIG. 1 shows in schematic form a reactant tube for use in the method of the present invention. In particular, the reactant tube comprises a first zone (1) and a second zone (2), downstream of the first zone, each zone comprising a plurality of electrically heated sections. In FIG. 1 the heated sections are schematically represented by individual heaters. Thus, as shown in FIG. 1, the first zone (1) has four heated sections/heaters, and the remaining heated sections/heaters form the second zone (2). (It is noted that not all sections of the second zone (2) are shown.)

At the end of the reactant tube is a quench zone (3) in which hot cracked gases exiting the reactant tube are cooled.

In FIG. 1, hydrocarbon feed to be cracked if fed via the inlet (4) to the reactant tube. It is vaporised in the first zone (1), cracked in the second zone (2) and then quenched in the quench zone (3) to form a cooled cracked gas mixture, which is recovered through outlet (5). In this FIG. 1 quenching takes place by indirect contact with a quench fluid which is fed via inlet (6) and removed via outlet (7). Typically, this would be water, which is passed in through the inlet (6) and removed in the form of steam at the outlet (7).

The number of sections in the first zone (1) and the second zone (2) can be changed by adjusting the heating, in particular by adjusting at least the heating provided to the fourth or fifth heated section in this case.

FIG. 2 also shows in schematic form a reactant tube for use in the method of the present invention. The numbering is as for FIG. 1. However, in this FIG. 2, the hydrocarbon feed to be cracked is introduced from the inlet (4) first to the quench zone (3) where it is indirectly contacted with hot cracked gas and pre-heated, before it is passed to the reactant tube. Due to the preheating less energy is required to vaporise the hydrocarbon feed in the first zone (1), and hence in this FIG. 2 the first zone (1) requires only two sections/heaters. The third and fourth heated sections and all subsequent sections/heaters form the second zone (2).

FIGS. 1 and 2 may be individually considered as examples of configurations which could be applied before or after a transition. They may also be considered together as an example of suitable configurations during and after a start-up, a more specific example of which is provided in Example 2 below.

### EXAMPLES

### Example 1

This Example illustrates the change of the number of heating sections in the first zone and in the second zone when performing a transition.

Cracking is performed in a reactant tube. The tube is 15 meters in length in total, with an internal diameter of 47 mm and outer diameter of 53 mm. The reactant tube is formed of 15 electrically heated sections each 1 meter in length and each heated by an independently controlled electrical heater (i.e. one heater provided every meter of tube). The tube metal temperature is measured by thermocouples.

Analysis of the feedstock is performed by a near infrared analyser correlated with an ASTM D86 laboratory analyser to provide a distillation temperature profile, and using a densimeter to measure the feedstock density.

In the first cracking process the feedstock is a naphtha. The analyses determine that the feedstock has a density of 0.715 g/cm3 and a distillation temperature profile as follows:

| % volume distilled | Temperature (°C) |
|---|---|
| 0 | 32 |
| 10 | 38 |
| 20 | 44 |
| 30 | 52 |
| 40 | 61 |
| 50 | 79 |
| 60 | 95 |
| 70 | 112 |
| 80 | 129 |
| 90 | 149 |
| 100 | 163 |

This naphtha at a flow rate is 250 kg/h is mixed with 75 kg/h of water steam, and is fed to the reactant tube. The feedstock temperature at the inlet is 128 °C and the pressure is 530 kPaa. It is determined from the analysis that the feedstock can be fully vaporised by provision of 30.9 kW of electrical power, and that this energy can be provided by a single electrically heated section (i.e. the first section) in the reactant tube. Thus, the first zone comprises the first heated section. The remaining 14 heated sections form a second zone in which the hydrocarbon feed can be cracked. Thus, in this process n1 is 1, and n2 is 14. The feedstock is passed to the reactant tube under these conditions and cracked. The gas temperature at the end of the vaporisation zone is 136 °C. The cracked gas temperature at the end of the cracking zone/end of the reactant tube is 820 °C, this being a typical cracking temperature for naphtha. The average heat transfer to the reactant tube is 150 kW/m2.

It is desired to transition to a second cracking process in which the feedstock is a gas oil. Analysis of the gas oil is performed and it is found that it has a density of 0.8233 g/cm3 and a distillation temperature profile as follows:

| % volume distilled | Temperature (°C) |
|---|---|
| 0 | 101.5 |
| 10 | 196 |
| 20 | 221.3 |
| 30 | 230.4 |
| 40 | 244.1 |
| 50 | 254.2 |
| 60 | 270.4 |
| 70 | 285.1 |
| 80 | 300.5 |
| 90 | 322 |
| 100 | 379 |

During transition the feeding of naphtha is stopped and the feeding of gas oil is started.

This gas oil at a flow rate is 250 kg/h is mixed with 75 kg/h of water steam, and is fed to the reactant tube. The feedstock temperature at the inlet is 120 °C and the pressure is 530 kPaa. It is determined from the analysis that the feedstock can be fully vaporised by provision of 102.5 kW of electrical power, and in this process it is decided to use the first 6 metres of the reactant tube as a vaporisation zone (first zone). Thus, the first zone comprises six heated sections. The remaining 9 heated sections form a second zone in which the hydrocarbon feed can be cracked. Thus, in this process m1 is 6, and m2 is 9. In particular during the transition, as the gas oil starts to feed to the reactant tube, the electrical heat energy applied to the reactant tube between 2 and 6 m in length from the inlet is reduced so that these are converted from sections in the second zone to sections in the first zone for the second process.

The gas oil feedstock is passed to the reactant tube under these conditions and cracked. The feedstock is fully vaporised in the vaporisation zone, with a gas temperature at the end of the vaporisation zone of 301 °C. The cracked gas temperature at the end of the cracking zone/end of the reactant tube is 770 °C, this being a typical cracking temperature for gas oil.

### Example 2

This Example illustrates the change of the number of heating sections in the first zone and in the second zone when starting a process.

For this Example 2 the initial conditions at start-up are taken as the conditions for cracking of the gas oil feed in Example 1.

In particular, the gas oil at a flow rate is 250 kg/h is mixed with 75 kg/h of water steam, and is fed to the reactant tube. The feedstock temperature at the inlet is 120 °C and the pressure is 530 kPaa. The first zone comprises six heated sections. The remaining 9 heated sections form a second zone in which the hydrocarbon feed can be cracked. Thus, in this process s1 is 6, and s2 is 9.0

In particular in this Example this represents a process with a low level of pre-heating of the feed prior to the first zone, typical of a process start-up.

Once cracking is started and a hot cracked effluent gas is being produced at the outlet of the reactant tube then additional preheating of the incoming gas oil feed is performed by heat transfer from the hot cracked effluent gas to the gas oil in a quench zone. This increases the temperature of the preheated gas oil feed, this reaching 160 °C at the inlet of the reactant tube at steady state.

Because of this increased temperature, the energy required to fully vaporise the feedstock is reduced (from 102.5 kW of electrical power as noted above) to 40 kW of electrical power.

This can be achieved using the first 2 meters of the reactant tube as a vaporisation zone (first zone). Thus, the first zone can be reduced to comprise two heated sections. The remaining 13 heated sections form a second zone in which the hydrocarbon feed can be cracked. Thus, in this process the cracking is altered to a process where, at steady state, n1 is 2, and n2 is 13.

This process allows the optimum number of heating sections to be used for cracking at steady state whilst allowing for an improved start-up process.

(It will be apparent that, in practise, the number of sections used for vaporisation will likely not be reduced “directly” from 6 to 2, but can be reduced sequentially as the process start-up proceeds.)

1. A method for transitioning from a first process cracking a first hydrocarbon feed to a second process cracking a second hydrocarbon feed, wherein:
a) the first process comprises
a. passing the first hydrocarbon feed to a reactant tube which reactant tube comprises a first zone and a second zone, downstream of the first zone, each zone comprising one or more electrically heated sections,
b. heating the first hydrocarbon feed in the first zone in the one or more electrically heated sections to vaporise the first hydrocarbon feed, and
c. heating the vaporised first hydrocarbon feed in the second zone in the one or more electrically heated sections to crack the first hydrocarbon feed,
wherein the number of heated sections in the first zone is n1, the number of heated sections in the second zone is n2, and n1+n2 is equal to n, where n is the total number of heated sections,
b) the transitioning comprises stopping the feeding of the first hydrocarbon feed to the reactant tube and starting the feeding of the second hydrocarbon feed to the same reactant tube, and
c) the second process comprises
a. passing the second hydrocarbon feed to the reactant tube which reactant tube comprises a first zone and a second zone, downstream of the first zone, each zone comprising one or more electrically heated sections,
b. heating the second hydrocarbon feed in the first zone in the one or more electrically heated sections to vaporise the second hydrocarbon feed, and
c. heating the vaporised second hydrocarbon feed in the second zone in the one or more electrically heated sections to crack the second hydrocarbon feed,
wherein the number of heated sections in the first zone is m1, the number of heated sections in the second zone is m2, and m1+m2 is equal to n,
and wherein the second hydrocarbon feed is different to the first hydrocarbon feed, m1≠n1 and m2≠n2.

2. The method according to claim 1 wherein a final boiling point of a boiling point range of the second hydrocarbon feed is at least 20 °C different (higher or lower) than a final boiling point of a boiling point range of the first hydrocarbon feed.

3. The method according to claim 1 wherein a final boiling point of a boiling point range of the second hydrocarbon feed is higher than a final boiling point of a boiling point range of the first hydrocarbon feed and the number of heated sections in the first zone is increased during the transitioning (m1>n1).

4. The method according to claim 1 wherein a final boiling point of a boiling point range of the second hydrocarbon feed is lower than a final boiling point of a boiling point range of the first hydrocarbon feed and the number of heated sections in the first zone is decreased during the transitioning (m1<n1).

5. The method according to claim 1 wherein m1=n1±1 or m1=n1±2.

6. A method for starting a process for cracking a hydrocarbon feed, wherein the process at steady state comprises
a) passing the hydrocarbon feed to a reactant tube which reactant tube comprises a first zone and a second zone, downstream of the first zone, the first zone comprising one or more electrically heated sections and the second zone comprising two or more electrically heated sections,
b) heating the hydrocarbon feed in the first zone in the one or more electrically heated sections to vaporise the hydrocarbon feed, and
c) heating the vaporised hydrocarbon feed in the second zone in the two or more electrically heated sections to crack the hydrocarbon feed, wherein the number of heated sections in the first zone is n1, the number of heated sections in the second zone is n2, and n1+n2 is equal to n, where n is the total number of heated sections,
wherein a start-up of the process comprises
a. starting a feeding of the hydrocarbon feed to the reactant tube,
b. heating the hydrocarbon feed in a first zone comprising two or more electrically heated sections to vaporise the hydrocarbon feed, and
c. heating the vaporised hydrocarbon feed in a second zone comprising one or more electrically heated sections to crack the hydrocarbon feed,
wherein the number of heated sections in the first zone at start-up is s1, the number of heated sections in the second zone at start-up is s2, and s1+s2 is equal to n, and wherein s1>n1 and s2<n2.

7. The method according to claim 6 wherein the number of heated sections in the first zone at start-up, s1, is one more than the number of heated sections in the first zone at steady state, n1.

8. The method according to claim 6 wherein the number of heated sections in the first zone at start-up, s1, is at least two more than the number of heated sections in the first zone at steady state, n1.

9. The method according to claim 1 wherein there are 4 to 10 heated sections in total (n is 4 to 10), and the first zone and the second zone each comprise at least two heated sections (n1 and n2 are both at least 2).

10. The method according to claim 1 wherein there is more than one reactant tube, the more than one reactant tubes being provided in parallel so that vaporisation and cracking can take place in each tube.

11. The method according to claim 1 wherein a temperature of the vaporised hydrocarbon feed at an exit of the first zone is less than 600 °C.

12. The method according to claim 1 wherein a temperature at an exit of the second zone is at least 700 °C.

13. The method according to claim 1 wherein there is provided a quench section downstream of the heated sections of the reactant tube, and in which the cracked products are cooled by indirect heat exchange with incoming (fresh) hydrocarbon feed.

14. The method according to claim 6 wherein there are 4 to 10 heated sections in total (n is 4 to 10), and the first zone and the second zone each comprise at least two heated sections (n1 and n2 are both at least 2).

15. The method according to claim 6 wherein there is more than one reactant tube, the more than one reactant tubes being provided in parallel so that vaporisation and cracking can take place in each tube.

16. The method according to claim 6 wherein a temperature of the vaporised hydrocarbon feed at an exit of the first zone is less than 600 °C.

17. The method according to claim 6 wherein a temperature at an exit of the second zone is at least 700 °C.

18. The method according to claim 6 wherein there is provided a quench section downstream of the heated sections of the reactant tube, and in which the cracked products are cooled by indirect heat exchange with incoming (fresh) hydrocarbon feed.
